(19) United States
(12) Patent Application Publication
(10) Pub. No.: US 2025/0304080 A1
(43) Pub. Date: Oct. 2, 2025

(54) EVALUATION OF CONVERGENCE TIME AND ADJUSTMENT BASED ON EVALUATION OF CONVERGENCE TIME

(71) Applicant: MERCEDES-BENZ GROUP AG, Stuttgart (DE)

(72) Inventors: Janis PEUKERT, San Francisco, CA (US); Jakob SIEGEL, Brisban, CA (US); Andrei VATAVU, Sunnyvale, CA (US)

(21) Appl. No.: 18/872,988

(22) PCT Filed: Jun. 13, 2023
(86) PCT No.: PCT/EP2023/065775

§ 371 Date: Dec. 9, 2024

Related U.S. Application Data
(60) Provisional application No. 63/351,628, filed on Jun. 13, 2022.

(51) Int. Cl. B60W 50/00; B60W 50/06

(52) U.S. Cl. CPC B60W 50/0098; B60W 50/0097; B60W 50/06

(57) ABSTRACT

The convergence time of one or more parameter values tracked by a vehicle is determined and used, for example, to adjust the vehicle system or vehicle component, or more particularly an operation performed by the vehicle system or vehicle component. The convergence time can be an amount of time for parameter values to satisfy a defined condition (e.g., to converge toward a value or set of values defined to be reference values). The convergence time can alternatively be to an amount of time for a level of error to satisfy a defined condition, such as by decreasing to becoming less than or equal to a defined threshold.

### TECHNICAL FIELD

Embodiments of the disclosed subject matter generally relate to systems and methods, including computer program products, for evaluating the convergence time of predicted, measured, inferred, or otherwise estimated values produced by a vehicle system or vehicle component and, for example, adjusting the vehicle system or component based on the evaluation.

### BACKGROUND

Vehicles are currently designed to comply with governmental regulations, as well as follow international standards, such as those provided by the International Standards Organization (ISO). These regulation and standards define requirements that vehicles must achieve. For example, these regulations or standards specify that semi-autonomous and autonomous control systems should meet certain levels of accuracy in order for the systems to control some or all of the driving functions of the vehicle. If these levels of accuracy are not achieved, the systems may be prevented from controlling some or all of the driving functionality of the vehicle. Analysis and evaluation of these systems therefore may be focused on accuracy of results.

Analysis focused on processing time and accuracy of results may be complicated by faulty or missing data, imprecise measurements, or unpredictable result values. This can result in incorrect adjustment of vehicle systems or components, or incorrect conclusions that the vehicle system or vehicle component meets governmental or standards-defined requirements. Accordingly, it would be desirable to provide systems and methods for evaluating vehicle systems and vehicle components and adjusting the vehicle systems or components based on the evaluation in a manner that can address faulty or missing data, imprecise measurements, and unpredictable result values.

### SUMMARY

Exemplary embodiments are directed to systems and methods for evaluating convergence time of a series of values for one or more parameters that are predicted, measured, estimated, or inferred by a vehicle system (or, more generally, by one or more vehicle components) and adjust the vehicle system or vehicle component based on the convergence time evaluation.

In one aspect the convergence time is a time it takes for a series of values of a parameter output from the vehicle system or vehicle component to satisfy a defined (e.g., predefined or dynamically defined) condition. The convergence time evaluation can be based on a single series of values output from the vehicle system/component or multiple series of values output from the vehicle system/component.

In another aspect the convergence time is a time it takes for a deviation between a series of values of a parameter output from the vehicle system or vehicle component and a series of reference values for the parameter to satisfy a defined (e.g., predefined or dynamically defined) condition. The convergence time evaluation can be based on a single series of values for a parameter output from the vehicle system/component and a single series of reference values or multiple series of values for a parameter output from the vehicle system/component and multiple series of reference values.

In an aspect, each value in the series of values output by the vehicle system/component includes a timestamp. In another aspect, each value in the series of reference values include a timestamp.

The vehicle system or vehicle component can be, for example, an electronic control unit, integrated device controller, or sensor. In an aspect, the vehicle system or vehicle component is, for example, a vehicle safety system or object recognition component.

[Claims will be inserted here once the claims are finalized]

### BRIEF DESCRIPTION OF THE DRAWINGS

The accompanying drawings, which are incorporated in and constitute a part of the specification, illustrate one or more embodiments and, together with the description, explain these embodiments. In the drawings:

FIGS. 1A-1C are schematic illustrations of a vehicle according to embodiments;

FIGS. 2A and 2B are flowcharts of exemplary methods according to embodiments;

FIG. 3 is a graph illustrating a series of values of a parameter output from a vehicle system/component and a series of reference values according to embodiments;

FIG. 4 is a graph illustrating the convergence time of a series of estimated velocity values and a series of reference velocity values according to embodiments;

FIG. 5 includes graphs illustrating error function vs. sample convergence times vs. defined condition according to embodiments;

FIG. 6 includes graphs illustrating error function vs. sample convergence times vs. defined condition according to embodiments;

FIG. 7 is a graph illustrating first diverging sample events according to embodiments;

FIG. 8 is a graph illustrating convergence time based on mean diverging samples according to embodiments;

FIGS. 9 and 10 are graphs illustrating relative convergence time for the same data but with different defined conditions according to embodiments; and

FIG. 11 is a graph illustrating a relative convergence time curve for different defined conditions according to embodiments.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments. Additionally, the term “or” in this specification refers to “and/or”.

Exemplary embodiments are directed to systems and methods for determining convergence time of a series of values for a parameter being tracked by a vehicle (e.g., by a sensing system of the vehicle). The one or more parameter values may each be an estimated value that is predicted, measured, estimated, or inferred by a vehicle system or vehicle component (e.g., sensing system that processes outputs from one or more sensors). In some implementations, the convergence time may be used to evaluate an operation being performed by the vehicle system, and/or used to adjust the operation being performed by the vehicle system or vehicle component. Non-limiting examples of the parameter include perceived object velocity, object position, Intersection over Union (IoU) score between two objects, Mahalanobis distance, Kalman Filter innovation, Manhattan Distance, cosine dissimilarity distance, loss function of a machine learning component, number of objects in the scene, the state of a leading vehicle, different values that describe the state of the surrounding environment of a vehicle while driving or while performing parking functions, etc.

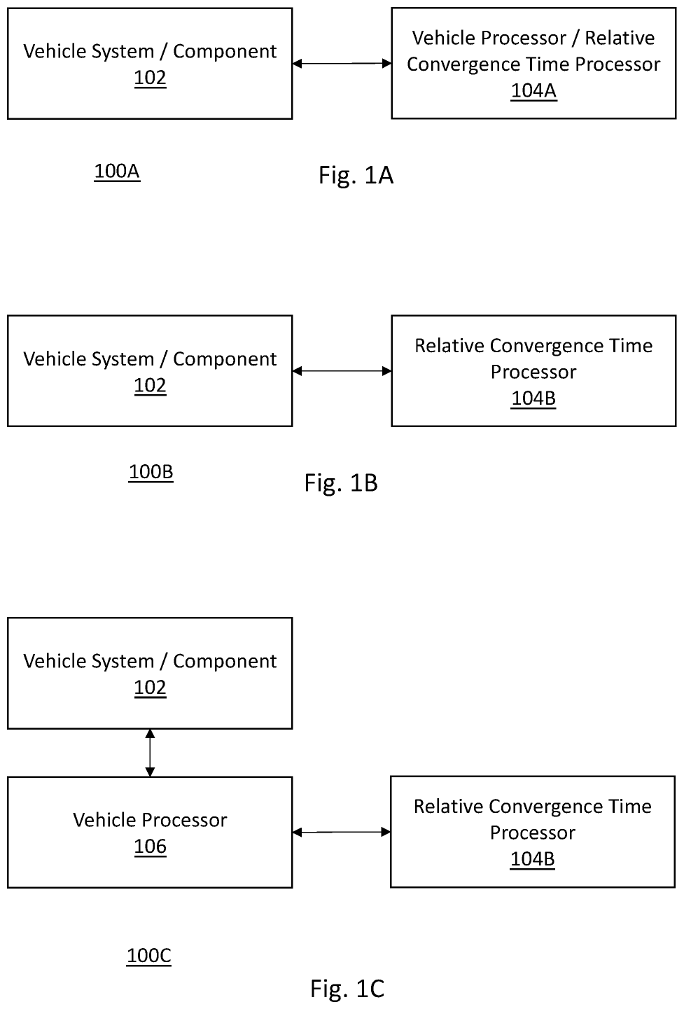

FIGS. 1A-1C are schematic illustrations of a vehicle with vehicle systems/components according to embodiments. FIG. 1A illustrates a vehicle 100A that includes a vehicle system/component 102 coupled to a processor 104A of the vehicle. The vehicle system/component 102 can also be referred to as a sensing system. In some instances, the processor may be configured to further adjust an operation of the vehicle system/vehicle component 102 based on the convergence time (details of which are described in more detail below).

FIG. 1B illustrates a vehicle 100B that includes a vehicle system/component 102 coupled to a processor 104B configured to execute a module that evaluates convergence time and adjusting the vehicle system/component 102 based on the evaluation (details of which are described in more detail below).

FIG. 1C illustrates a vehicle 100C that includes a vehicle system/component 102 coupled, via a processor 106, to processor 104B, which includes a dedicated hardware or software for evaluating convergence time and adjusting the vehicle system/component 102 based on the evaluation (details of which are described in more detail below). In the vehicle of FIG. 1A, the processor 104A is one that performs the relative convergence time processing in addition to other types of processing, whereas the processor 104B in FIGS. 1B and 1C are processors that are dedicated to performing the relative convergence time processing. Thus, for example, processor 104A can be the vehicle's main processor. As another example, processor 104A can be a sensor processor that processes sensor signals, as well as performs the relative convergence time processing. Further, processor 106 can be the vehicle's main processor or another processor that couples the relative time convergence processor 104B with the vehicle system/component 102.

The processors 104A and 104B may include hardware configured to execute software, or more generally to execute steps of a method, such as a method for determining convergence time. In an embodiment, the processors described herein may include at least one of: microprocessors, system on a chip (SoC's), field programmable gate arrays (FPGAs), application specific integrated circuits (ASICs), microcontroller, and the like. Although not specifically illustrated, the processors 104A, 104B, and/or 106 can include a memory storing processor-executable code to perform the functions disclosed herein, as well as other functions. The memory can be any type of non-transitory memory.

In the vehicles illustrated in FIGS. 1A-1C the vehicle system/component 102, processor 104A or 106, and the relative convergence time processor 104B can be coupled to each other, as appropriate, by a direct connection of via a system bus, such as the CAN bus commonly employed in vehicles. The vehicle system/component 102 can be any system or component that predicts, measures, estimates, or infers a parameter. Non-limiting examples vehicle system/component 102 include an electronic control unit (ECU), integrated device controller (IDC), sensor (e.g., radar, LIDAR, image sensor, etc.), object recognition system, automated parking system, system for preventing collisions during parking, cross-traffic alert system, collision prevention system, driving system (e.g., adaptive cruise control, automated lane keeping and/or control, emergency brake assistance system, semi-autonomous drive system, autonomous drive system, occupant safety system (e.g., seatbelt and/or airbag deployment system), pedestrian safety system, and the like, which can be implemented by hardware or as software executed on hardware.

It should be recognized that the three vehicle configurations illustrated in FIGS. 1A-IC are non-limiting examples and that the systems and methods described below can be implemented in a number of different vehicle configurations without departing from the invention.

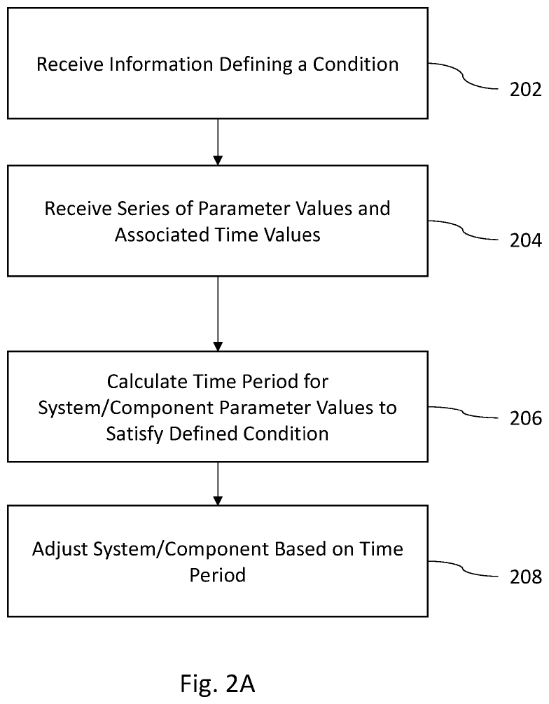

FIGS. 2A and 2B illustrate methods performed by the vehicles illustrated in FIGS. 1A-1C. Turning first to FIG. 2A, a processor 104A or 104B receives information defining a condition used as part of the evaluation (step 202). The vehicle system/component 102 outputs a series of values of a parameter (hereinafter parameter values) and a time associated with each value (hereinafter time values) of the series of parameter values, which are received by the processor 104A or 104B (step 204). The time values can be, for example, a timestamp. If a timestamp is not associated with the values, the values can be organized by indexing. The series of parameter values is predicted, measured, estimated, inferred, or otherwise determined by the vehicle system/component 102. The processor 104A or 104B uses the series of parameter values and the associated time values to calculate a time period (also referred to as an amount of time or elapsed time) for these values to satisfy the defined condition (step 206). In an embodiment, this time period may measure how much time is taken or how much time is needed for the series of parameter values to converge to satisfy the defined condition, and thus may be referred to as a relative convergence time. In this example, the defined condition may also be referred to herein as the acceptance criterion or criteria. In some implementations, the processor 104A or 104B then adjusts the vehicle system/component 102 based on the time period (step 208). It should be recognized that in some instances the calculated time period is acceptable, in which case step 208 can be omitted.

Turning now to FIG. 2B, the processor 104A or 104B receives information describing a defined condition used as part of the evaluation (step 210). The vehicle system/component 102 outputs a series of parameter values and associated time values, which are received by the processor 104A or 104B (step 212A). The parameter is predicted, measured, estimated, or inferred by the vehicle system/component 102. The processor 104A or 104B also receives a series of reference values with associated time values (step 212B). These reference values are also referred to herein as ground truth values. Again, the time values associated with the parameter values is also referred to herein as a timestamp. If a timestamp is not associated with the parameter values, the parameter values can be organized by indexing. Although FIG. 2B illustrates steps 212A and 212B as being performed in parallel, these values and associated times can be received serially by the processor 104A or 104B. Further, these values and associated times can be received as a batch or as they are produced by the vehicle system/component 102.

The processor 104A or 104B correlates the series of parameter values output by the vehicle system/component with the series of reference values based on the associated time values (step 214). This allows for the series of parameter values output by the vehicle system/component 102 to be aligned in time with corresponding series of reference values. The processor 104A or 104B determines a deviation between the time-aligned values and determines a time period for this deviation to satisfy the defined condition (step 216). This deviation is also referred to herein as an error value. The processor 104A or 104B then adjusts the vehicle system/component 102 based on the time period (step 218). It should be recognized that in some instances the calculated time period is acceptable, in which case step 218 can be omitted.

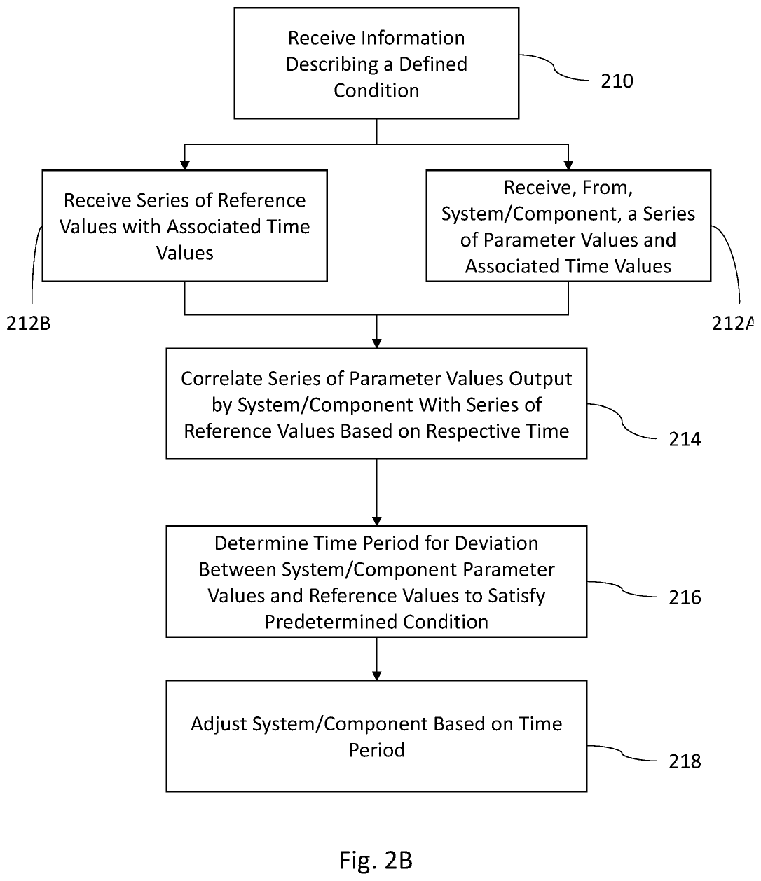

Now that an overview of exemplary aspects has been provided, a more detailed discussion of the system and method are provided in connection with FIGS. 3-11.

FIG. 3 illustrates a graph of the convergence time-related values in a sequence of estimated and reference values. The left-most dot on the x-axis is a sample event time, while the right-most dot on the x-axis is a convergence event time, i.e., the point in time where a difference between an output of the vehicle system/component 102 (labeled “estimated result value”) and a reference value satisfies an acceptance criterion, which in the graph of FIG. 3 is a point in time in which an amount of error is below or equal to a defined error threshold. Plot 302 represents the output of the output of the vehicle system/component 102 and plot 304 represents the series of reference values. The relative convergence time of a sample (Sample-RCT) is represented in FIG. 3 as the left-most vertical line, having a length that is directly proportional with the distance (elapsed time) between the sample event (left-most dot on the x-axis) and convergence point (right-most dot on the x-axis).

Each parameter value provided by vehicle system/component 102 is received by the processor 104A or 104B and treated as an individual sample event Sᵢ that occurs at a given moment in time t_{Si} and is described by a given value xᵢ:

$${S}_{i} = \{ {x}_{i} , {t}_{si} \} \qquad ( 1 )$$

For i=1 . . . N_{S}, where N_{S} is the number of samples that are available for computing the relative convergence time.

The acceptance criterion Aᵢ of a sample Sᵢ describes a time-invariant function having a binary result (true or false). In this non-limiting example, the function Aᵢ returns true if the sample value Sᵢ satisfies a given Boolean expression P(Sᵢ) or false, otherwise:

$${A}_{i} ( {S}_{i} ) = \{ \begin{matrix}true , if P ( {S}_{i} ) is satisfied \\ false , otherwise\end{matrix} \qquad ( 2 )$$

An example of an acceptance Boolean expression is whether a given error Err(xᵢ) of the value xᵢ is below a given threshold Tₑᵣᵣ:

$$P ( {S}_{i} ) : Err ( {x}_{i} ) \leq {T}_{err} \qquad ( 3 )$$

In the above formula the error function Err(xᵢ) of a given value xᵢ can be defined as the absolute value of the difference between the estimated value xᵢ and the ground-truth x_{gt,i} (reference) value:

$$E r r ( {x}_{i} ) = \vert {x}_{gt , i} - {x}_{i} \vert \qquad ( 4 )$$

For the sake of simpler notation x_{gt,i} will be referred to as x_{gt}.

Using the error and Boolean expression are exemplary implementations and different, other Boolean expressions P(Sᵢ) can be adopted to specify the exact acceptance criteria Aᵢ. As will be appreciated by the discussion herein, the disclosed systems and methods can involve other types of Boolean expressions and acceptance criteria, as well as can operate in the presence of different information types, missing data, or noisy results.

Further, the sample rate of the reference values might differ from the sample rate of the parameter values output by the vehicle system/component 102. This discussion assumes that all these particular specifications are defined and addressed by the operator, based on specific use-case. In other words, it is assumed that for each sample event the acceptance criterion can be computed (i.e., in the above example, for each sample event there are reference values available).

The convergence point describes a “converged” sample event for which the acceptance criterion Aᵢ(Sᵢ) is true and for which the previous sample event acceptance criterion Aᵢ₋₁(Sᵢ₋₁) was false. In other words, the value xᵢ converges towards its pre-defined acceptance criterion Aᵢ(Sᵢ), for example, when the error of xᵢ is below a threshold Tₑᵣᵣ.

The sample event relative convergence time, Sample-RCT(Sᵢ), for a given sample Sᵢ represents the elapsed time between the current Sᵢ event and its closest convergence point event T(i) (which is in the future).

$$T ( i ) = \{ \begin{matrix}{t}_{S i} + Δ {t}_{max} if {A}_{a} ( {S}_{a} ) = false ∀ a \geq i \\ {t}_{S c} where {A}_{a} ( {S}_{c} ) = true , {A}_{d} ( {S}_{d} ) = false ∀ i < d < c\end{matrix} \qquad ( 5 )$$

where a describes the index of any sample event Sₐ or acceptance criteria Aₐ that occurs after the current sample event Sᵢ, and d describes the index of any sample event S_{d} or acceptance criteria A_{d} that can occur between the current sample event Sᵢ and its corresponding convergence point at index c.

Considering that the sample event Sᵢ occurs at t_{Si} and the next closest convergence point event occurs at time T(i) the Sample-RCT(Sᵢ) can be expressed as (see FIG. 3):

$$Sample - RCT ( {S}_{i} ) = Δ {t}_{i} = T ( i ) - {t}_{S i} \qquad ( 6 )$$

When the convergence point is not available (for example, when all the future sample events are never converging towards the “acceptance criteria”) the Sample-RCT(Sᵢ) is Δtₘₐₓ and can be chosen to be zero or non-zero.

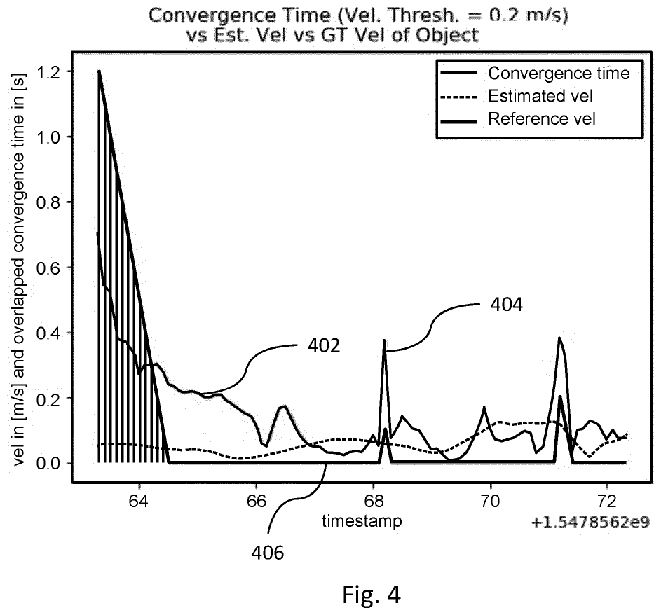

A “batch of Sample-RCT values” (or simply a “batch”) describes the set of all the consecutive non-zero Sample-RCT that are calculated before a given convergence point (see FIG. 5) or before the end of a sequence (if there is no found convergence point).

Considering the notations above, the sequence relative convergence time can be defined, which will be referred simply as RCT (omitting the world “Sequence”). In a non-limiting embodiment, the RCT is defined as a sample mean, and is computed as the average of all Sample-RCT(Sᵢ):

$$R CT = Sequence - RCT = \frac{1}{{N}_{s}} {\sum }_{i = 1}^{N} Sample - RCT ( {S}_{i} ) = \frac{1}{{N}_{s}} {\sum }_{i = 1}^{N} Δ {t}_{i} = \frac{1}{{N}_{s}} {\sum }_{i = 1}^{N} ( T ( i ) - {t}_{S i} ) \qquad ( 7 )$$

The unbiased RCT sample variance represents a measure of RCT uncertainty and can be calculated as:

$${σ}_{R C T}^{2} = \frac{1}{{N}_{s} - 1} {\sum }_{i = 1}^{N} {( Sample - RCT ( {S}_{i} ) - R C T )}^{2} = \frac{1}{{N}_{s} - 1} {\sum }_{i = 1}^{N} {( ( T ( i ) - {t}_{S i} ) - R C T )}^{2} \qquad ( 8 )$$

The RCT sample variance indicates how far the sample RCT values are spread out from their average RCT. The lower the variance, the more confidence can be found in the provided RCT.

For calculating RCT, it is assumed that sample events Sᵢ are independent events.

If the Sample-RCT(Sᵢ) values are normally distributed, the probability distribution with the mean μ=RCT and the standard deviation σ_{RCT} maximizes the likelihood for the normal distribution N(μ=RCT, σ_{RCT}) given the sequence of sample events.

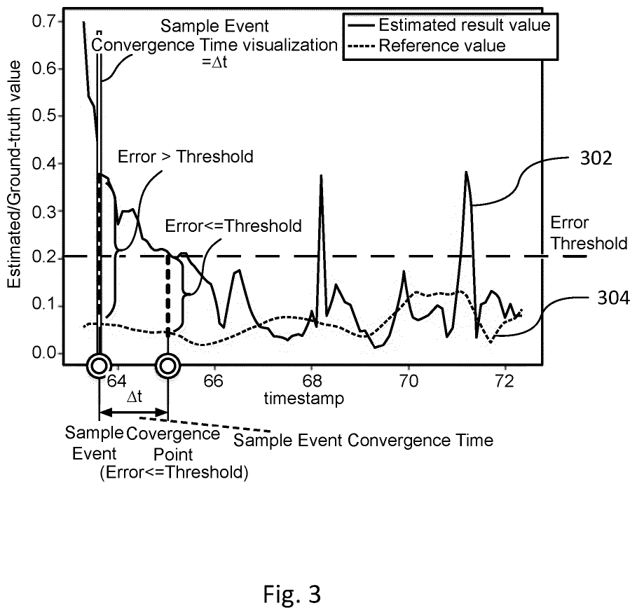

FIG. 4 illustrates a sequence-RCT calculated using parameter values that are a sequence of estimated velocities (vel) of an object, which are provided by a vehicle ECU. If the ECU is used for performing a perception function, the ECU may be referred to as a “Perception ECU”. In FIG. 4 the velocity estimation 404 is for one single object provided by a vehicle perception ECU. These parameter values are the input to the processor 104A or 104B. The plot 402 is the reference velocity. The absolute difference between plots 402 and 404 provides the Vel. Error. The Acceptance Criteria in this example is whether the Vel. Error is less than 0.2 m/s. All the vertical lines are the estimated Relative Convergence (RCT) values for each sample event in time. It can be seen that, for example, it took 1.2 seconds for the estimation component to converge, first time the object is identified (first vertical line). Later, if the time 64 is used as the reference point, then the sample event RCT value decreases to 0.6. Finally, after convergence the RCT time is 0, which means that the values output by processor 104A or 104B algorithm already converged with the reference values within the Vel. Error and there is no estimation time delay. It also can be seen that around time 68 or 71.5, due to high estimation error, the sample event RCT calculation is returning positive RCT values, which are interpreted as the time required for the parameter values output by the processor 104A or 104B to recover to its desired acceptance criterion (around 0.1-0.2 seconds).

To summarize, the use-case described above provides a specific example for calculating the RCT values, with the following details:
The sample event value xᵢ: described by the detected object velocity: xᵢ=velᵢ
The Boolean expression used for acceptance criterion:

$$P ( {S}_{i} ) : Error ( {x}_{i} ) \leq {T}_{err} = \vert {vel}_{i} - {vel}_{gt , i} \vert \leq {T}_{err} \qquad ( 9 )$$

where Tₑᵣᵣ is the error threshold, set to 0.2 (m/s), velᵢ is the estimated velocity and vel_{gt,i} is the ground-truth velocity.
The acceptance criterion function is described as:

$${A}_{i} ( {S}_{i} ) = \{ \begin{matrix}true , if \vert {vel}_{i} - {vel}_{gt} \vert \leq {T}_{err} if satisfied \\ false , otherwise\end{matrix} \qquad ( 10 )$$

The difference between an ideal/theoretical use-case for calculating the RCT and the usual real use-cases will now be discussed and it will be demonstrated that the calculation of RCT can be applied for any of these use-cases.

Although the use-case described above employs an error (or error function) as the defined condition (i.e., acceptance criterion), different defined conditions can be employed in other use-cases. In a non-limiting example in which the vehicle system/component 102 implements a computer vision function, the defined condition can be the number of edges of an object that are identified in a captured image.

For a better representation, FIG. 5 is describing the case when the acceptance criterion is based on the Error function:

$$Error ( i ) = \vert {x}_{gt , i} - {x}_{i} \vert \qquad ( 11 )$$

and a given component's parameter values are converged to the acceptance criterion when the error function is below a given threshold:

$$P ( {S}_{i} ) : Error ( i ) < Threshold \qquad ( 12 )$$

Thus, the error function (difference between the reference values and the parameter values output by the vehicle system/component 102) is directly plotted instead of showing the original result values, like the ones shown in FIG. 3 or FIG. 4.

FIG. 5 illustrates the error function vs sample convergence Times (vertical bars) vs acceptance Criterion. This example can be referred to as an “ideal” example, with the error function described by a monotonically decreasing function, where sample times are equidistant and having only one single convergence point. In such cases, the RCT can be analytically reduced to the following result:

$$R C T = \frac{Δ {t}_{1}}{2} = \frac{( {t}_{C 1} - {t}_{S 1} )}{2} \qquad ( 13 )$$

Where Δt₁ is the Sample-RCT for the first available sample event (the first received result value at time t_{C1}) and t_{S1} is the convergence point time step. The relation above can be deducted from interpreting the distribution of vertical RCT bars. This can be performed in two different ways:
(1) The average Sample-RCT is the middle of the segment that connects the first Sample-RCT(S₁) and the convergence point.
(2) The distribution of Sample-RCTs describe a right triangle with both orthogonal sides of length Δt₁.

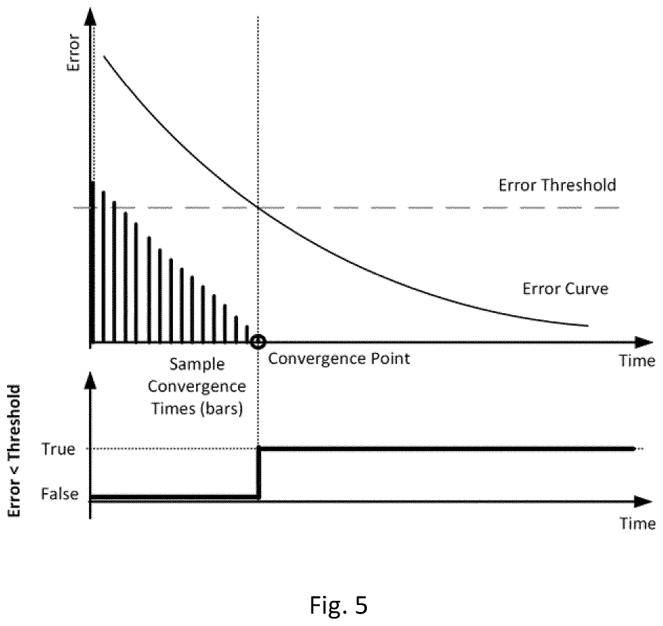

Unlike the ideal use-case, the actual result data used as an input to the processor 104A or 104B looks something like in the FIG. 6, which illustrates error function vs. sample convergence times (vertical bars) vs acceptance criterion.

Calculating the convergence-related values can be affected by the following:
Missing data: The events might come with missing information—not all the errors/data samples are available.
Out of order sample events: The sample events might not be sorted in time (might not be provided in order), therefore the RCT calculation should be able to deal with “out of order” sequences, for example, by sorting the sample events by timestamp/index.
Arbitrary data or error functions: The real data (i.e., parameter values outputted by the vehicle system/component 102) might be corrupted, or inaccurate. The output of the processor 104A or 104B that has to be evaluated might provide unpredictable outcomes. Therefore, as an example, unlike FIG. 5, the real error function might be described by an arbitrary shape (not necessarily a nice monotonically decreasing function). Consequently, multiple convergence points might be provided. A simple, closed form solution to compute RCT is not suitable in this case.
Unknown Convergence Points: The convergence point might be unknown (it is not known whether or not the output values of the processor 104A or 104B will converge with the reference values). This is common especially for the last sequence data samples, for which a convergence point is not available in the future (no information).
Overlapping data: multiple events (i.e., parameter values outputted by the vehicle system/component 102) can be acquired/received at the same time.
Non-uniform/multiple “acceptance criteria”: multiple sample events (i.e., parameter values outputted by the vehicle system/component 102) that can be acquired at the same time, can be described by different “acceptance criteria”. This excludes the possibility of simple reasoning as in the “ideal” use-case.

As will be appreciated from the discussion above, the processor 104A or 104B is able to handle all of the above constraints and challenges, providing a reliable information that is consistent and direct proportional to the convergence time of the component that is being evaluated.

Furthermore, the disclosed system and method can work with components with different automotive safety integrity level (ASIL) capabilities.

The calculation of the RCT can performed by a dedicated component (e.g., FIGS. 1B and 1C) for a single vehicle system/component 102, or it can be performed by a common component (e.g., the processor 104A in FIG. 1A or the processors 104B in FIGS. 1B and 1C) for a number of vehicle systems/components 102, which reduces costs by avoiding implementing, and re-building specific evaluators for specific components).

As will be appreciated from the discussion above, the RCT provides important information about the performance of vehicle systems/components 102, and this information can be used to adjust the operation of vehicle systems/components 102 to improve the performance of vehicle systems/components 102. The variations of the RCT can also provide important information for evaluating and adjusting vehicle systems/components 102, including RCT based on first diverging sample events (RCT-FDS), RCT based on mean diverging samples (RCT-MDS), RCT curve, and overall RCT convergence sensitivity, each of which will now be described in more detail.

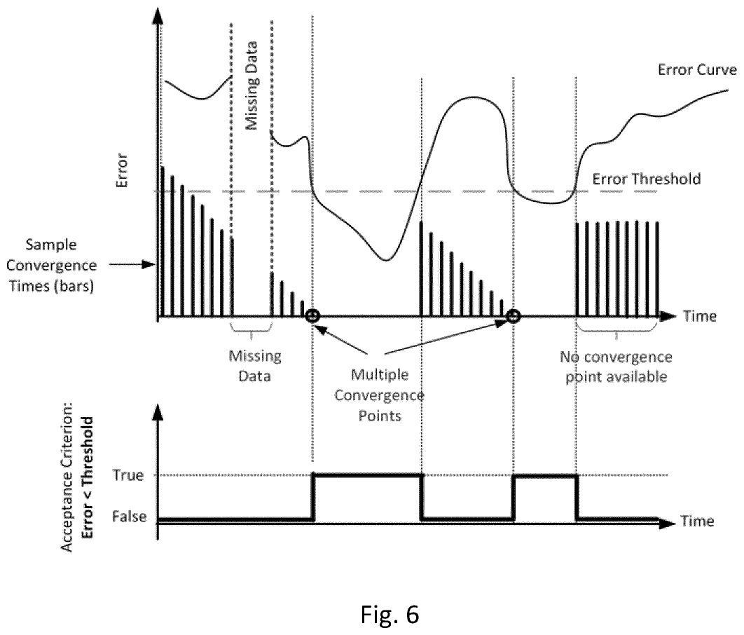

FIG. 7 illustrates the first diverging Sample-RCT values, which are the first samples in a group of continuous data samples (this example shows 3 distinct Sample-RCT groups). An approximation of RCT calculation considers only these samples. RCT based on first diverging sample represents an approximation. Considering that the error function might converge/diverge several times, the RCT-FDS only accounts for the first Sample-RCT(Sᵢ) in a batch of continuous Sample-RCT values, before a given convergence point. These first data samples describe the events when the result data goes out of acceptance criterion or, in other words, the result data diverges (the opposite of convergence points).

The first diverging sample-RCT values are be biased towards the worst case scenarios because only the sample-RCT values with maximum convergence times are considered. The advantage of this technique is faster processing times at the expense of it being less precise for use-cases containing missing data samples (gaps in the result data).

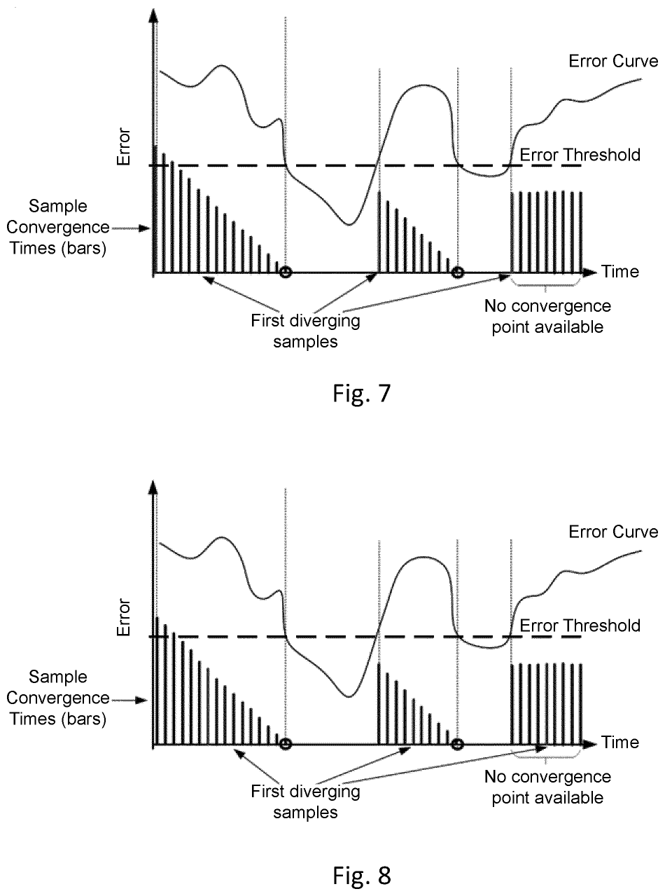

RCT based on mean diverging sample (RCT-MDS) will be described in connection with FIG. 8. The calculation of RCT based on Mean Diverging Sample is similar to the previously described RCT-FDS. As will be appreciated by comparing FIGS. 7 and 8, the difference is that for each batch of continuous RCT values, the mean Sample-RCT(Sᵢ) accounted for in the calculation of the final sequence-level RCT. RCT based on mean diverging sample results in lower complexity and lighter processing (i.e., fewer Sample-RCT candidates to be processed, memorized etc.), at the expense of being less accurate on sequences with missing data, or in the use-cases with multiple acceptance criteria.

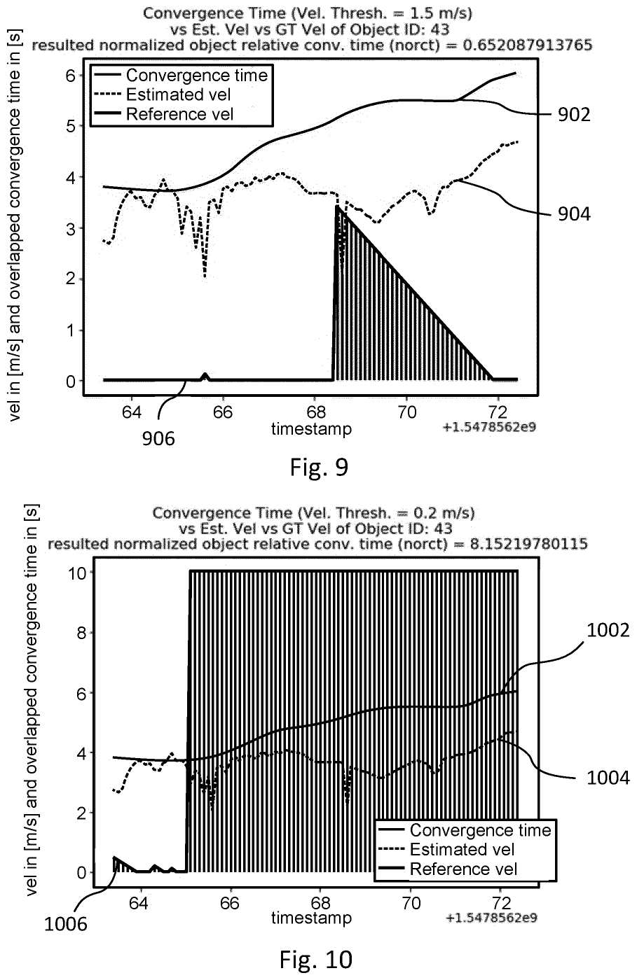

The RCT curve will now be described in connection with FIGS. 9 and 10. In the process of RCT calculation, the acceptance criteria function can use specific thresholds. The calculated RCT values depends on the value of the set threshold. For example, as presented in FIG. 4, for Velocity-RCT the following Acceptance Criteria function is used:

$${A}_{i} ( {S}_{i} ) = \{ \begin{matrix}true , if \vert {vel}_{i} - {vel}_{gt} \vert \leq {T}_{err} is satisfied \\ false , otherwise\end{matrix} \qquad ( 2 )$$

Where Tₑᵣᵣ represents the Velocity Error Threshold.

FIGS. 9 and 10 illustrate how the RCT result is influenced by the error threshold. In FIG. 9 plot 902 represents the reference velocity, plot 904 represents the velocity output of the vehicle system/component 102, plot 906 represents the convergence time, and the vertical lines represent the RCTs. In FIG. 10 plot 1002 represents the reference velocity, plot 1004 represents the velocity output (i.e., parameter values) by the vehicle system/component 102, plot 1006 represents the convergence time, and the vertical lines represent the RCTs.

For a Vel. Error Threshold of 1.5 m/s (see FIG. 9, noted with “Vel. Thresh.”), an RCT of 0.65 s (noted in the figure with “norct”) is obtained. For a Vel. Error Threshold of 0.2 m/s (see FIG. 10) an RCT value of 8.15 s is obtained. It will be appreciated that the distribution of Sample-RCT values (vertical bars) are different in each of these cases, i.e., the RCT does not converge towards the used “acceptance criteria” for the most part of the sequence, if a smaller threshold of 0.2 m/s is used (see FIG. 10).

The RCT Curve provides a better understanding of how the RCT evolves, based on different constraints adopted via acceptance criteria. Therefore, RCT Calculation is repeated on the entire data set for different acceptance criteria sampled from a range of possibilities. For example, in the Velocity-RCT case, exemplified in the above figures, the RCT Curve is calculated by plotting multiple RCT values, calculated with different Velocity Error Thresholds.

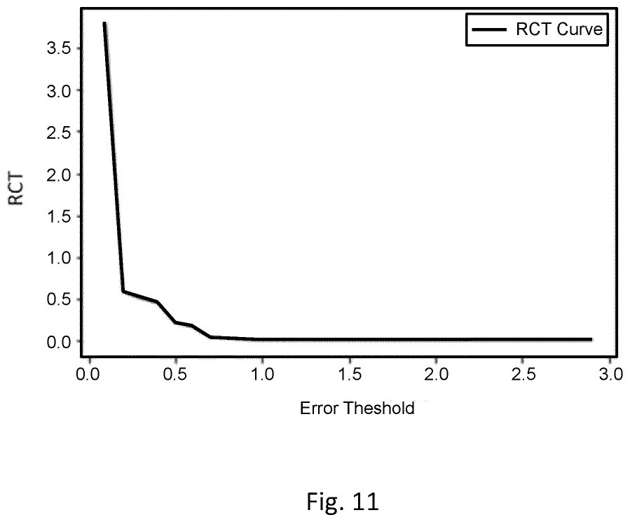

Overall convergence sensitivity (RCT Sensitivity) will now be described in connection with FIG. 11, and its calculation can be summarized by the following steps:
1. Compute the RCT Curve—RCTs for a list of sampled acceptance criteria.
2. Calculate the sum over all RCTs calculated in the previous step:

$$S U {M}_{R C T} = {\sum }_{j = 1}^{{N}_{K}} R C T ( {A}_{j} ) \qquad ( 14 )$$

where:
RCT(Aⱼ)—describes the calculation of RCT in the iteration j by using a specific acceptance criterion function Aⱼ; and
Nₖ— the number of iterations, each iteration j represents a separate calculation of RCT(Aⱼ) with a specific acceptance criterion Aⱼ.
3. Compute the integral of the worst case curve. In the worst case, for every iteration of step 2, we would get Δtₘₐₓ—the time assigned for the cases when the estimation never converges:

$$NormFactor = {N}_{K} Δ {t}_{max} \qquad ( 15 )$$

4. Compute convergence sensitivity:

$$R C T S ensitivity = 1 - \frac{S U {M}_{R C T}}{NormFactor} \qquad ( 16 )$$

It will be appreciated that if the algorithm converges, its SUM_{RCT} is close to zero, and subsequently the RCTProbability is close to 1, and if the algorithm never converges, its SUM_{RCT}=N_{K}Δtₘₐₓ and therefore the convergence probability RCTProbability is close to zero.

The discussion above in connection with velocity as the parameter value output by the vehicle system/component 102 is merely exemplary and any other parameter value output by the vehicle system/component 102 can be employed. For example, an image recognition output by the vehicle system/component can have an acceptance criteria that at least five lines of an object must be identified before the object is considered. Thus, the output from the vehicle system/component 102 can be a series of parameter values of the number of lines of the object that are identified, and the RCT value would be the time it takes for the vehicle system/component output to indicate that five lines of an object are identified.

Furthermore, although the discussion involves a single vehicle system/component and a single parameter, the processor 104A or 104B can process outputs from a number of vehicle systems/components, each having one or more parameters that are analyzed for relative convergence time, which can then be used to adjust the respective one of the vehicle systems/components.

The disclosed embodiments provide systems and methods for evaluating convergence time and adjusting a vehicle system/component based on the evaluation of the convergence time of outputs of vehicle system/component. It should be understood that this description is not intended to limit the invention. On the contrary, the exemplary embodiments are intended to cover alternatives, modifications, and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

Without in any way limiting the scope, interpretation, or application of the claims appearing below, a technical effect of one or more of the example embodiments disclosed herein is ability to determine whether or not the time convergence of a series of values output by a vehicle system/component complies with governmental regulations and/or international standards so that such vehicle system/components can be operated on public roads.

If desired, the different functions discussed herein may be performed in a different order and/or concurrently with each other. Furthermore, if desired, one or more of the above-described functions may be optional or may be combined. Although various aspects of some of the embodiments are set out in the independent claims, other aspects of some of the embodiments comprise other combinations of features from the described embodiments and/or the dependent claims with the features of the independent claims, and not solely the combinations explicitly set out in the claims. It is also noted herein that while the above describes example embodiments, these descriptions should not be viewed in a limiting sense. Rather, there are several variations and modifications that may be made without departing from the scope of some of the embodiments as defined in the appended claims.

1. A method, comprising:
outputting, by a vehicle system or vehicle component of a vehicle, a series of parameter values and a series of time values associated with the series of parameter values, wherein the series of parameter values are estimated values predicted, measured, estimated, inferred, or otherwise determined by the vehicle system or vehicle component;
receiving, by a processor of the vehicle from the vehicle system or vehicle component, the series of parameter values and associated the series of time values;
determining, by the processor, a time period for the series of parameter values to satisfy a defined condition using at least one time value of the series of time values;
outputting, by the processor, the time period; and
adjusting the vehicle system or vehicle component based on the output time period.

2. The method of claim 1, wherein the series of parameter values include a first series of parameter values and second series of parameter values, and wherein the time period determined by the processor includes a first time period for the first series of parameter values to satisfy the defined condition, and includes a second time period for the second series of parameter values to satisfy the defined condition.

3. The method of claim 1, wherein the vehicle system or vehicle component is or includes at least one of: an electronic control unit, integrated device controller, or sensor.

4. The method of claim 1, wherein the vehicle system is a safety system of the vehicle, or wherein the vehicle component is a component of the safety system of the vehicle.

5. The method of claim 1, wherein the series of parameter values are a series of velocity values.

6. The method of claim 1, wherein the vehicle system or vehicle component includes an object recognition system and wherein the series of parameter values are a number of sides of an object recognized by the object recognition system.

7. The method of claim 1, further comprising:
receiving, by the processor, a series of reference values and a series of time values, wherein each time value of the series of time values is respectively associated with one value of the series of reference values;
correlating, by the processor using the series of time values associated with each of the parameter values of the first series of parameter values and the series of time values associated the values of the series of reference values, each of the values of the first series of parameter values with a corresponding one of the values of the series reference values produce a series of correlated value sets and associated correlated times; and
determining, by the processor, a difference between each value of each correlated value set of the series of correlated value sets,
wherein the determination of the time period for the series of parameter values to satisfy the defined condition comprises
determining, by the processor, a time period for the series of correlated value sets to satisfy a defined condition using the time values associated with the first series of parameter values and associated correlated times.

8. A vehicle, comprising:
a vehicle system or vehicle component configured to output a series of parameter values and a series of time values associated with the series of parameter values, wherein the parameter values are predicted, measured, estimated, or inferred by the vehicle system; and
a processor configured to:
receive, from the vehicle system or vehicle component, the series of parameter values and the associated series of time values;
determine a time period for the series of parameter values to satisfy a defined condition using at least one time value of the series of time values; and
output the time period,
wherein the vehicle system or vehicle component is adjusted based on the output time period.

9. The vehicle of claim 8, wherein the series of parameter values include a include a first and second series of parameter values, and the time period determined by the processor includes a first time period for the first series of parameter values to satisfy the defined condition and a second time period for the second series of parameter values to satisfy the defined condition.

10. The vehicle of claim 8, wherein the vehicle system or vehicle component is an electronic control unit, integrated device controller, or sensor.

11. The vehicle of claim 8, wherein the vehicle system is a safety system of the vehicle or the vehicle component is a component of the safety system of the vehicle.

12. The vehicle of claim 8, wherein the series of parameter values are velocity values.

13. The vehicle of claim 8, wherein the vehicle system or vehicle component includes an object recognition component and the series of parameter values are a number of sides of an object recognized by the object recognition component.

14. The vehicle of claim 8, wherein the processor is configured to perform the receiving, determining, processing, outputting, and adjusting, as well as being configured to process other data for operating the vehicle.

15. The vehicle of claim 8, wherein the processor is further configured to:
receive a series of reference values and a series of time values, wherein each time value of the series of time values is respectively associated with one value of the series of reference values;
correlating, using the series of time values associated with each of the parameter values of the first series of parameter values and the series of time values associated the values of the series of reference values, each of the values of the first series of parameter values with a corresponding one of the values of the series reference values produce a series of correlated value sets and associated correlated times; and
determine a difference between each value of each correlated value set of the series of correlated value sets,
wherein the determination of the time period for the series of parameter values to satisfy the defined condition comprises
determining a time period for the series of correlated value sets to satisfy a defined condition using the time values associated with the first series of parameter values and associated correlated times.

16. A method, comprising:
outputting, by a vehicle system or vehicle component of a vehicle, a first series of parameter values and a series of time values, wherein each time value of the series of time values is respectively associated with one parameter value of the first series of parameter values, wherein parameter values of the series of parameter values are predicted, measured, estimated, or inferred by the vehicle system or vehicle component;
receiving, by a processor of the vehicle from the vehicle system or vehicle component, the first series of parameter values and the associated series of time values;
receiving, by the processor, a series of reference values and a series of time values, wherein each time value of the series of time values is respectively associated with one value of the series of reference values;
correlating, by the processor using the series of time values associated with each of the parameter values of the first series of parameter values and the series of time values associated the values of the series of reference values, each of the values of the first series of parameter values with a corresponding one of the values of the series reference values produce a series of correlated value sets and associated correlated times;
determining, by the processor, a difference between each value of each correlated value set of the series of correlated value sets;
determining, by the processor, a time period for the series of correlated value sets to satisfy a defined condition using the time values associated with the first series of parameter values and associated correlated times;
outputting, by the processor, the time period; and
adjusting the vehicle system or the vehicle component based on the output time period.

17. The method of claim 16, wherein the first series of parameter values and the series of reference values each include an initial and subsequent series of values, and the time period determined by the processor includes a first time period for the initial series of values to satisfy the defined condition and a second time period for the subsequent series of values to satisfy the defined condition.

18. The method of claim 16, wherein the vehicle system or vehicle component is an electronic control unit, integrated device controller, or sensor.

19. The method of claim 16, wherein the vehicle system is a safety system of the vehicle or the vehicle component is a component of the safety system of the vehicle.

20. The method of claim 16, wherein the parameter of the first series of parameter values is velocity.

21. (canceled)
